(19) United States
(12) Patent Application Publication
(10) Pub. No.: US 2005/0173341 A1
(43) Pub. Date: Aug. 11, 2005

(54) Blended polymer media for treating aqueous fluids

(75) Inventor: Richard F Salinaro, Hastings on Hudson, NY (US)

Correspondence Address: LEYDIG VOIT & MAYER, LTD, 700 THIRTEENTH ST. NW, SUITE 300, WASHINGTON, DC, 20005-3960, US

(73) Assignee: Pall Corporation, East Hills, NY (US)

(21) Appl. No.: 10/513,134

(22) PCT Filed: May 1, 2003
(86) PCT No.: PCT/US03/13573

Related U.S. Application Data
(60) Provisional application No. 60/377,210, filed on May 3, 2002.

(51) Int. Cl. B01D 65/02

(52) U.S. Cl. 210/636; 210/650; 210/490; 210/500.27

(57) ABSTRACT

Blended polymer membranes for treating aqueous fluids, filters including the membranes, and methods of treating aqueous fluids such as source water to remove contaminants to a desired level of purification by directing the water through the membranes, are disclosed.

### CROSS-REFERENCE TO RELATED PATENT APPLICATIONS

This patent application claims the benefit of U.S. Provisional Patent Application No. 60/377,210, filed May 3, 2002, which is incorporated by reference.

### FIELD OF THE INVENTION

This invention pertains to media and methods for treating fluids, especially aqueous fluids, and in particular, relates to media for use in water purification.

### BACKGROUND OF THE INVENTION

Filter media have been used for source water treatment, e.g., industrial source water treatment or municipal drinking water treatment, and for wastewater treatment, e.g., industrial wastewater treatment or municipal wastewater treatment, to remove undesirable matter such as particulate matter, viruses, microorganisms, dissolved materials, and various other contaminants. However, such filter media have suffered from a variety of drawbacks, particularly with respect to fouling of the media caused by, for example, the accumulation of particulates, microorganisms, and organic matter, or the growth of a biofilm, on the media. The fouling can cause a reduction in the flow rate or the flux (i.e., the flow rate per unit area of the filter medium) of water through the filter medium. Accordingly, as the filter medium fouls, the pressure (e.g., the differential pressure or the transmembrane pressure (TMP)) necessary to force water through the filter medium at a given flow rate must be increased. However, while the applied pressure can be increased, filtration must be suspended (e.g., the filter media and/or filter device may be taken offline) before the pressure reaches a level that would cause damage to the filter medium or the housing containing the filter medium. Once filtration is suspended, the filter medium is cleaned or replaced. Cleaning the filter medium typically includes, for example, reversing the normal flow of fluid through or across the medium, or flushing the medium in the same direction as operational flow, so as to dislodge and remove accumulated particulates from the upstream surface of the filter medium (or media) so that the flux through the medium is at least partially restored. Some cleaning protocols include chemically treating the medium. However, filter media that foul quickly and/or are difficult to clean are inefficient and increase the expense of water treatment.

Other conventional filter media used in water purification, including granular filters containing mono- or multimedia such as carbon, anthracite, sand and/or gravel, suffer from many other drawbacks. For example, these media require great quantities of material contained in large beds, and the expense and downtime for taking the filter offline for cleaning and/or replacing these media can be enormous.

The present invention provides for ameliorating at least some of the disadvantages of the prior art. These and other advantages of the present invention will be apparent from the description as set forth below.

### BRIEF SUMMARY OF THE INVENTION

In an embodiment of the invention, a method of treating an aqueous fluid is provided, comprising directing the fluid through a porous blended polymer membrane or a semipermeable blended polymer membrane having an upstream surface and a downstream surface, the membrane comprising a blend of a first, essentially hydrophobic polymer component and a second polymer component that is a homopolymer or random copolymer entangled with the first polymer component, the second polymer component being more hydrophilic than the first polymer component. In some embodiments, the second polymer component is present at one surface in a ratio to the first polymer component that is greater than the overall ratio in the membrane of the second polymer component to the first polymer component. In other embodiments, the second polymer component is present in a ratio to the first polymer component that is substantially uniform at the surfaces and through the bulk of the membrane. Preferably, embodiments of the method include stopping the flow of the aqueous fluid to be treated through the membrane, cleaning the membrane, and resuming the flow of aqueous fluid through the membrane. In more preferred embodiments, the aqueous fluid to be treated is source water, and the method includes removing contaminants in the fluid to provide water with a desired level of purification.

In accordance with embodiments of the invention, the blended polymer membrane can have a variety of configurations, including planar, pleated, and hollow cylindrical.

A membrane according to an embodiment of the invention comprises a blended polymer hollow fiber membrane having an inside surface and an outside surface, and a bore, the membrane comprising a blend of a first, essentially hydrophobic polymer component and a second polymer component that is a homopolymer or a random copolymer entangled with the first polymer component, the second polymer component being more hydrophilic than the first polymer component. The second polymer component can be present at the inside surface or the outside surface in a ratio to the first polymer component that is greater than the overall ratio in the membrane of the second polymer component to the first polymer component. In another embodiment, the second polymer component is present in a ratio to the first polymer component that is substantially uniform at the surfaces and through the bulk of the membrane.

A membrane according to another embodiment of the invention comprises a blended polymer membrane having an upstream surface and a downstream surface, the membrane comprising a blend of a first, essentially hydrophobic polymer component and a second polymer component that is a homopolymer or a random copolymer entangled with the first polymer component, the second polymer component being more hydrophilic than the first polymer component, the second polymer component being present in a ratio to the first polymer component that is substantially uniform at the surfaces and through the bulk of the membrane.

A filter element according to yet another embodiment of the invention comprises a blended polymer membrane having an upstream surface and a downstream surface, and at least one support or drainage layer adjacent to at least one surface of the membrane, the membrane comprising a blend of a first, essentially hydrophobic polymer component and a second polymer component that is a homopolymer or a random copolymer entangled with the first polymer component, the second polymer component being more hydrophilic than the first polymer component. The support or drainage layer can be adjacent the upstream surface and/or the downstream surface of the membrane, and in some embodiments, a first support or drainage layer is adjacent the upstream surface of the membrane, and a second support or drainage layer is adjacent the downstream surface of the membrane. The filter element (or a filter comprising the filter element) can further comprise at least one additional layer, for example, the filter can further comprise at least one drainage layer (e.g., adjacent one surface of the membrane) and at least one support layer (e.g., adjacent the surface of the drainage layer not facing the membrane). Embodiments can include support and drainage layers upstream and downstream of the membrane.

Embodiments of the invention also include filter modules, filter cartridges, filter assemblies, and systems for treating aqueous fluids, especially source water. In accordance with preferred embodiments of the invention, the membranes, filter elements, modules, cartridges, and assemblies, are cleanable and reusable.

### BRIEF DESCRIPTION OF THE DRAWINGS

FIG. 1 illustrates a cross-sectional view of portion of an embodiment of a pleated filter according to the present invention, including a blended polymer membrane and support and drainage layers upstream and downstream of the membrane.

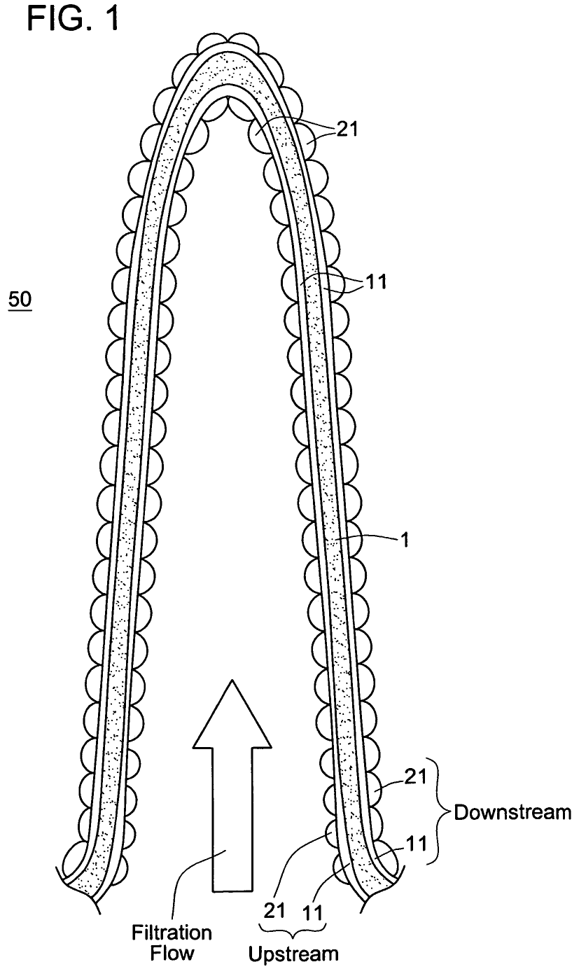

### DETAILED DESCRIPTION OF THE INVENTION

In accordance with an embodiment of the present invention, a method of treating an aqueous fluid comprises directing the flow of an aqueous fluid to be treated through a blended polymer membrane having an upstream surface and a downstream surface, the membrane comprising a blend of a first, essentially hydrophobic polymer component and a second polymer component that is a random copolymer or a homopolymer entangled with the first polymer component, the second polymer component being more hydrophilic than the first polymer component, the second polymer component being present at the upstream surface in a ratio to the first polymer component that is greater than the overall ratio in the membrane of the second polymer component to the first polymer component; stopping the flow of the aqueous fluid through the membrane; cleaning the membrane; and directing the flow of additional aqueous fluid to be treated through the membrane.

Another embodiment of a method of treating an aqueous fluid provided by the invention comprises directing the flow of an aqueous fluid to be treated through a blended polymer membrane having an upstream surface and a downstream surface, the membrane comprising a blend of a first, essentially hydrophobic polymer component and a second polymer component that is a random copolymer or a homopolymer entangled with the first polymer component, the second polymer component being more hydrophilic than the first polymer component, the second polymer component being present in a ratio to the first polymer component that is substantially uniform at the surfaces and through the bulk of the membrane; stopping the flow of the aqueous fluid through the membrane; cleaning the membrane; and directing the flow of additional aqueous fluid to be treated through the membrane.

In yet another embodiment, a method of treating an aqueous fluid comprises passing an influent aqueous fluid through a blended polymer hollow fiber membrane having an inside surface, an outside surface, and a bore, to provide an effluent aqueous fluid passing through the surfaces of the membrane, the effluent aqueous fluid containing a lower concentration of undesirable material than the influent aqueous fluid, the hollow fiber membrane comprising a blend of a first, essentially hydrophobic polymer component and a second polymer component that is a random copolymer or a homopolymer entangled with the first polymer component, the second polymer component being more hydrophilic than the first polymer component.

In accordance with another embodiment of the invention, a membrane is provided comprising a blended polymer hollow fiber membrane having an inside surface and an outside surface, and a bore defined by the inside surface, the membrane comprising a blend of a first, essentially hydrophobic polymer component and a second polymer component that is a random copolymer or a homopolymer entangled with the first polymer component, the second polymer component being more hydrophilic than the first polymer component, the second polymer component being present in a ratio to the first polymer component that is substantially uniform at the surfaces and through the bulk of the membrane.

In another embodiment, a blended polymer hollow fiber membrane has an inside surface and an outside surface, and a bore defined by the inside surface, the membrane comprising a blend of a first, essentially hydrophobic polymer component and a second polymer component that is a random copolymer or a homopolymer entangled with the first polymer component, the second polymer component being more hydrophilic than the first polymer component, the second polymer component being present at the inside surface or the outside surface in a ratio to the first polymer component that is greater than the overall ratio in the membrane of the second polymer component to the first polymer component.

In accordance with another embodiment, a membrane is provided comprising a blended polymer membrane having an upstream surface and a downstream surface, the membrane comprising a blend of a first, essentially hydrophobic polymer component and a second polymer component that is a homopolymer or a random copolymer entangled with the first polymer component, the second polymer component being more hydrophilic than the first polymer component, the second polymer component being present in a ratio to the first polymer component that is substantially uniform at the surfaces and through the bulk of the membrane.

Preferably, the second polymer component comprises a comb polymer including a hydrophobic, water insoluble backbone and hydrophilic (more preferably, low molecular weight) side chains.

In some embodiments of membranes according to the invention, the first polymer component comprises a halopolyolefin (for example, polyvinylidene fluoride (PVDF)), and the second polymer component comprises a comb polymer including a halopolyolefin backbone (for example, a PVDF backbone) or a methyl acrylate backbone, or the first polymer component comprises polyacrylonitrile (PAN), and the second polymer component comprises a comb polymer including a PAN backbone, or the first polymer component comprises a sulfone and the second polymer component comprises a comb polymer including a sulfone backbone.

Embodiments of membranes according to the invention can be semipermeable, or porous, typically, microporous.

In preferred embodiments of the invention, at least one filter element is provided, the filter element comprising at least one blended polymer membrane as described above. In some embodiments, the filter element further comprises at least one additional layer, preferably, a support layer and/or a drainage layer. A support layer or a drainage layer can be adjacent the downstream and/or the upstream surfaces of the blended polymer membrane. In some embodiments, the filter element (or, more typically, a filter comprising the filter element) further comprises a plurality of support layers and/or drainage layers. For example, a support layer and a drainage layer can be arranged upstream or downstream of the membrane.

One embodiment of a method of preparing a membrane according to the invention comprises providing a composition comprising a blend of at least first and second miscible polymer components and a solvent, mixing a nonsolvent with the composition to provide a casting solution, casting the casting solution in the form of a sheet, removing the nonsolvent, and recovering the membrane.

In an embodiment, a method of preparing a hollow fiber membrane comprises providing a spinning dope comprising a viscous polymer solution comprising a blend of at least first and second miscible polymer components, a solvent, and optionally, least one of a pore former and a nonsolvent, extruding the dope in the form of a hollow pre-fiber from a nozzle, the pre-fiber having an inside surface and an outside surface, contacting the outside surface of the pre-fiber with a coagulating medium, and coagulating the pre-fiber from the outside surface to the inside surface to provide a blended polymer hollow fiber membrane.

A filter provided according to an embodiment of the invention comprises a first filter element and a second filter element, the first filter element comprising a hollow filter element comprising a porous blended polymer membrane, the membrane comprising a blend of a first, essentially hydrophobic polymer component and a second polymer component that is a homopolymer or a random copolymer entangled with the first polymer, the second polymer component being more hydrophilic than the first polymer component; and, the second filter element comprising at least one porous hollow fiber membrane, the second filter element being disposed in the hollow portion of the first filter element. Preferably, the second filter element comprises two or more hollow fiber membranes, and in some embodiments, the hollow fiber membranes comprise blended polymer membranes.

A filter module according to an embodiment of the invention comprises a filter element comprising two or more semipermeable or porous blended polymer hollow fiber membranes, each membrane having an inside surface and an outside surface, and a bore defined by the inside surface, the membrane comprising a blend of a first, essentially hydrophobic polymer component and a second polymer component that is a homopolymer or a random copolymer entangled with the first polymer component, the second polymer component being more hydrophilic than the first polymer component.

In another embodiment, a filter cartridge is provided comprising a filter element comprising two or more semipermeable or porous blended polymer membranes, each membrane having an upstream surface and a downstream surface, the membrane comprising a blend of a first, essentially hydrophobic polymer component and a second polymer component that is a homopolymer or random copolymer entangled with the first polymer component, the second polymer component being more hydrophilic than the first polymer component.

A filter assembly for treating an aqueous fluid according to an embodiment of the invention comprises a housing including an inlet for receiving the aqueous fluid to be treated, an outlet for discharging the treated aqueous fluid, and at least one filter element comprising a blended polymer membrane disposed between the inlet and the outlet. In those embodiments wherein the filter assembly operates in a cross flow mode of filtration, the housing includes a process fluid or feed fluid inlet for receiving the aqueous fluid to be treated, a filtrate or permeate outlet for discharging the portion of treated fluid passing through the filter element, and a retentate outlet for discharging the portion of fluid not passing through the filter element. In some embodiments, the filter assembly is capable of operating in both cross flow and dead end modes of filtration, although little or no retentate will pass through the retentate outlet when the assembly is operated in the dead end mode. Embodiments of filter assemblies according to the invention can comprise two or more filter cartridges or two or more hollow fiber modules.

In some embodiments, the filter assembly is a component of a system, e.g., wherein the system comprises an inlet for receiving the aqueous fluid to be treated, an outlet for discharging the treated aqueous fluid (in cross flow applications, a filtrate or permeate outlet, and a retentate outlet), and at least one filter assembly comprising at least one element comprising a blended polymer membrane disposed between the inlet and the outlet.

A variety of aqueous fluids can be treated in accordance with the invention, and embodiments of the invention include generating ultrapure water sources for the electronics and pharmaceutical industries, and treating aqueous fluids in the food and beverage (including, but not limited to, beer and wine), and pulp and paper industries. Other aqueous fluids that can be treated include, for example, photoresists, etchants, and plating baths (e.g., for use in the electronics industry).

Purification of aqueous fluids, particularly source water and wastewater, preferably includes removing undesired substances or contaminants, including but not limited to particulates; human and animal waste; various biological substances, such as bacteria and/or protozoa, e.g., E. coli, Cryptosporidium and Giardia (including their oocysts and/or cysts), and/or viruses; and various chemical substances, such as harmful or noxious chemical elements and compounds, including various inorganic substances, e.g., phosphorous, nitrogen, metals such as iron, manganese, and arsenic and various organic compounds. Preferably, purification includes controlling turbidity, e.g., ensuring the turbidity of filtered water used for drinking is no higher than 1 nephelolometric turbidity units (NTU), more preferably, no higher than 0.3 NTU in 95% of daily samples in any month, even more preferably, no higher than 0.05 NTU in 95% of daily samples in any month.

The present invention can preferably be used to treat source water, such as municipal drinking water, water from natural sources such as lakes, rivers, reservoirs, surface water, ground water and storm water runoff, or industrial source water, or wastewater, such as industrial wastewater or municipal wastewater. Source water may also include treated wastewater which has, for example, been purified after industrial use.

Embodiments of the invention include membranes, filter elements, filters, filter assemblies, systems, and methods for treating water used for drinking or non-drinking purposes. Accordingly, embodiments of the invention include treating source water, including surface water, such as municipal water, ground water, or reservoir water, preferably, for drinking. Other embodiments of the invention include treating wastewater, so that the purified water may be suitable for drinking or may be reused for other non-drinking purposes. Wastewater may include any type of water which has been used and is no longer suitable for its intended purpose in its present form. For example, wastewater may include, but is not limited to, municipal wastewater, such as sewage, or industrial wastewater, such as effluent from an industrial process.

Preferably, the membranes and filter elements, as well as the filters, filter assemblies, filter cartridges, and filter modules, are cleanable, and more preferably, cleanable and reusable. For example, some filter elements have an anticipated life of several years or more of continuous use, in some applications, about 6-8 years, or more, of continuous use, and can be cleaned at least once, and more typically, several times each day, over the life of the elements. Typically, the filters, filter cartridges, and filter modules, are disposable and replaceable.

Various configurations of filter elements and filters may be used with the present invention, although, as noted below, at least one filter element comprises a porous or semipermeable blended polymer membrane, e.g., a flat sheet, a pleated sheet (including a pleated sheet with a plurality of axially extending pleats, for example, as disclosed in International Publication No. WO 00/13767), a hollow cylinder, a spiral-wound structure, or a hollow fiber.

The filter element can be used for dead end filtration and/or cross flow filtration. The. flow through the filter element may be outside-in, where the aqueous fluid to be treated, preferably source water, initially contacts the outside surface(s) of a filter element, with filtrate or permeate passing through the filter medium to the inside surface(s) of the filter element. Alternatively, the flow through the filter element may be inside-out, where the aqueous fluid initially contacts the inside surface(s) of a filter element, with filtrate or permeate passing through the filter medium to the outside surface(s) of the filter element. Illustratively, with respect to cross flow filtration wherein the filter element comprises one or more hollow fibers, one embodiment comprises directing an aqueous fluid to be treated into the central bore of the hollow fiber membrane, the membrane having an inside porous surface and an outside porous surface, passing a permeate from the inside surface to the outside surface, and passing a retentate along the inside surface and the central bore of the membrane. Another embodiment comprises directing an aqueous fluid to be treated toward the outside porous surface, passing a permeate from the outside surface to the inside surface and along the central bore of the membrane, and passing a retentate along the outside surface without passing into the central bore of the membrane.

Also, the filter element and/or filter may comprise a composite including additional layers, or the element and/or filter may further comprise additional layers that are in fluid communication with the filter medium or media, including support and/or drainage layers and/or cushioning layers.

The filter media used in at least one filter element, the filter element being suitable for purifying water by removing particles, such as solids, gels, or microbes, and/or by removing or inactivating chemical substances, such as ions or organic or inorganic compounds, comprises a porous or semipermeable blended polymer membrane having a first surface and a second surface (e.g., an upstream surface and a downstream surface, or an inside surface and an outside surface).

In some embodiments, the blend comprises a first, essentially hydrophobic polymer component and a second polymer component that is a random copolymer or a homopolymer, entangled with the first polymer component, the second polymer being more hydrophilic than the first polymer, wherein the first and second polymer components are miscible with each other at room temperature. Preferably, the polymer components are compatible, i.e., the second polymer component does not phase separate from the first polymer component. In some embodiments, the second polymer component is present at one surface (preferably, the first surface contacting the aqueous fluid to be treated) in a ratio to the first polymer component that is greater than the overall ratio in the membrane of the second polymer component to the first polymer component. In other embodiments, the second polymer component is present in a ratio to the first polymer component that is substantially uniform at the surfaces and through the bulk of the membrane.

In accordance with another embodiment of the invention, the blend comprises a first, relatively lower-cohesive-energy polymer component and a second, relatively higher-cohesive-energy polymer component entangled with the first polymer component, wherein the first and second polymer components are miscible with each other at room temperature. Preferably, the polymer components are compatible. Typically, the second polymer component is present at one surface in a ratio to the first polymer component that is greater than the overall ratio in the membrane of the second polymer component to the first polymer component, but in some embodiments, the second polymer component is present in a ratio to the first polymer component that is substantially uniform at the surfaces and through the bulk of the membrane.

In still other embodiments, the blend comprises first and second polymer components having an affinity to water, the first and second polymer components being entangled, and miscible with each other at room temperature. Preferably, the polymer components are compatible. Typically, one surface of the polymeric membrane has an affinity to water that is greater than the average water affinity of the total of the first and second polymers in the membrane, but in some embodiments, the polymeric membrane has a substantially uniform affinity to water at the surfaces and through the bulk of the membrane.

Typically, the first and second polymer components are thermodynamically compatible at room and use temperatures, and can be compatible as a melt. The first and second polymer components typically each have a weight average molecular weight of at least about 5,000, and preferably, the second polymer component has a weight average molecular weight of at least about 10,000, more preferably, at least about 15,000. The first and second polymer components can have different functionalities.

As noted above, in some embodiments, the second polymer component is present at one surface in a ratio to the first polymer component that is greater than the overall ratio in the membrane of the second polymer component to the first polymer component, or one surface of the polymeric membrane has an affinity to water that is greater than the average water affinity of the total of the first and second polymers in the membrane. However, in some other embodiments, the second polymer component is present in a ratio to the first polymer component that is substantially uniform at the surfaces and through the bulk of the membrane, or the polymeric membrane has a substantially uniform affinity to water at the surfaces and through the bulk of the membrane. Typically, in those embodiments where the second polymer component is present in a ratio to the first polymer component that is substantially uniform at the surfaces and through the bulk of the membrane, the concentration of the second polymer component in the membrane at the upstream and downstream surfaces does not vary by more than about 6 mole %. In some embodiments, the concentration of the second polymer component in the membrane at the upstream and downstream surfaces does not vary by more than about 4 mole %.

A variety of first and second polymer components can be used in accordance with the invention. Examples of polymers of polymer components include, for example, a halopolymer, i.e., one which contains one or more halogen atoms per repeat unit. The halogen atoms may be the same or different. Fluorinated polymers are particularly preferred, for example, fluoropolyolefin, e.g., polyvinylidene fluoride (PVDF) or a copolymer of hexafluoropropylene and vinylidene fluoride. The halopolyolefin may be a homopolymer or a copolymer, e.g., a copolymer of two or more haloolefins or a copolymer of a haloolefin and a non-haloolefin, e.g., ethylene, propylene, or butylene. long chain, linear or not highly branched polyacrylonitrile (PAN), a sulfone (including polysulfones such as aromatic polysulfones, for example, polyethersulfone, bisphenol A polysulfone, polyarylsulfone, and polyphenylsulfone), and an acrylate such as a methylmethacrylate (MMA), including polymethyl methacrylate (PMMA).

Preferably, the first polymer component comprises a long-chain, linear or not highly branched, halopolymer, i.e., one which contains one or more halogen atoms per repeat unit. The halogen atoms may be the same or different. Fluorinated polymers are particularly preferred. In an embodiment, the first polymer component comprises fluoropolyolefin, e.g., polyvinylidene fluoride (PVDF) or a copolymer of hexafluoropropylene and vinylidene fluoride. The halopolyolefin may be a homopolymer or a copolymer, e.g., a copolymer of two or more haloolefins or a copolymer of a haloolefin and a non-haloolefin, e.g., ethylene, propylene, or butylene. Other examples of polymers of first polymer components include, as listed above, long chain, linear or not highly branched polyacrylonitrile (PAN), a sulfone (including polysulfones such as aromatic polysulfones, for example, polyethersulfone, bisphenol A polysulfone, polyarylsulfone, and polyphenylsulfone), and an acrylate such as a methylmethacrylate (MMA), including polymethyl methacrylate (PMMA).

The second polymer component comprises a comb polymer, and can comprise a non-linear polymer (ionic or non-ionic), more preferably a branched polymer, of relatively high molecular weight that is compatible with the first polymer. For example, the second polymer component can be an acrylate, more preferably a homopolymer comprising acrylate or methacrylate monomers, or a random copolymer comprising two or more acrylate or methacrylate monomers, at least one of the monomers includes a hydrophilic side chain imparting hydrophilicity to the homopolymer or copolymer. The side chain can be essentially any hydrophilic moiety, such as, for example, N-isopropylacrylamide, or a polyalkylene oxide such as polyethylene glycol. A variety of chain ends of the side chains are suitable, including, for example, —COOH and —NH₃, preferable chain ends are —OH or —OCH₃. The second polymer component is preferably insoluble in water and has a molecular weight large enough so that it remains entangled with the first polymer component.

In some embodiments, the first and second polymer components are acrylate components, and each is the polymerization product of one or more monomers having the formula CH₂═C(R₁)(COOR₂), where R₁ and R₂ are each selected from the group consisting of hydrogen, hydrocarbon groups, heterocyclic, alkenyloxyalky, alkoxyalkyl, aryloxy, substituted hydrocarbon groups, and alcohol groups and R₁ and R₂ can be the same or different. Hydrocarbon groups such as alkyl, alkenyl, alkynyl, cycloalkyl, aryl, alkaryl, aralkyl, and the like may be selected. Examples of such groups are methyl, propenyl, ethynyl, cyclohexyl, phenyl, tolyl, benzyl, hydroxyethyl and the like. R₁ is typically selected from the group consisting of hydrogen and the general class of lower alkyl groups such as methyl, ethyl, propyl and the like. R₂ can be an alkyl group, typically having 1 to 24 carbon atoms, in some embodiments, 1 to 18 carbon atoms; an alkenyl group, typically having 2 to 4 carbon atoms; an aminoalkly group, typically having 1 to 8 carbon atoms, and optionally substituted on the nitrogen atom with or, more typically, two alkyl groups, typically having 1 to 4 carbon atoms; an alkyl group, typically having 1 to 4 carbon atoms, having a five- or six-membered heterocyclic ring as a substituent; an allyloxyalkyl group, typically having up to 12 carbon atoms; an alkoxyalkyl group, typically having a total of 2 to 12 carbon atoms; an aryloxyalkyl group, typically having 7 to 12 carbon atoms; an aralkyl group, typically having up to 10 carbon atoms; or a similar alkyl or aralkyl group having substituents which will not interfere with the polymerization of the acrylic components.

The first polymer component can be, for example, the polymerization product of a monomer having the formula CH₂═C(R₁)(COOR₂), where R₁ is H or CH₃, and R₂ is H or C1-C8 alkyl. The first polymer component can be a random polymer of a species such as this with a species in which R₂ is larger, but preferably, with no more than about 4 additional units in R₂. In one embodiment, the second polymer component is made by a copolymerization reaction including a monomer that constitutes the monomer of the first polymer component and a monomer in which R₂ is a polyethylene glycol. Specific examples of monomers suitable for polymerization to form a copolymer composition according to this embodiment of the invention include but are not limited to acrylonitrile, 2-ethylhexylmethacrylate, methymethacrylate, dodecylmethacrylate, vinylacetate, cyclohexylmethacrylate, 2-hydroxypropylmethacrylate, and acrylamide.

A variety of types of polymerization can be used to form components of the invention. For example, anionic polymerization, free-radical polymerization, or cationic polymerization can be used.

Some embodiments of blended polymer membranes according to the invention have a Critical Wetting Surface Tension (CWST, as described in U.S. Pat. No. 4,925,572) of at least about 72 dynes/cm (about 0.72 erg/mm²). In other embodiments, membranes according to the invention have CWSTs less than 72 dynes/cm, but, for example, are wettable under pressure (e.g., the pressures conventionally used in aqueous fluid treatment protocols). Advantageously, the wettability of the membrane (e.g., for membranes having a CWST of 72 dynes/cm or more, or wettable under pressure) can be maintained after cleaning the membrane at least once, and typically, two or more times.

A variety of polymers (including a variety of first and second polymer components) can be blended to provide at least one filter element comprising a polymeric membrane in accordance with the invention. Suitable blends include, but are not limited to, those disclosed in U.S. Pat. No. 6,413,621, as well as International Publication Nos. WO 98/08595 and WO 99/52560.

The blended polymer membrane can have a variety of configurations, e.g., a flat sheet, a pleated sheet, a cylinder, a hollow pleat, or a hollow fiber. Embodiments of the blended polymer membrane include isotropic or anisotropic, and asymmetric membranes, as well as composite, supported or unsupported membranes.

Blended polymeric media according to the invention are preferably produced by a phase inversion process. Phase inversion can be achieved by, for example, evaporation of a solvent, addition of a non-solvent, cooling of a solution, use of an additional polymer, or a combination thereof (see, for example, Mulder, M., Basic Principles of Membrane Technology, Kluwer Academic Publishers, Dordrecht, The Netherlands (1996), pp. 75-140; Kesting, R. E., et al., Synthetic Polymeric Membranes, New York, McGraw-Hill Book Co. (1971), pp. 116-157). The phase inversion can be, for example, entropically-driven, enthalpically-driven, or entropically- and enthalpically-driven. Thus, for example, a composition such as casting solution containing a blend of at least first and second miscible polymers, and a solvent (e.g., dimethyl formamide (DMF)), and optionally, at least one of a pore former (e.g., polyethylene glycol (PEG), a wetting agent (e.g., a surfactant), and a small quantity of a non-solvent (e.g., glycerine, isopropyl alcohol, or ethyl acetoacetate (EAA)), is prepared by combining and mixing the ingredients, preferably at an elevated temperature. The resulting solution is filtered to remove any impurities. The casting solution is cast or extruded in the form of a sheet or hollow fiber. Partial evaporation of the solvent may or may not be allowed to occur. The cast solution, film, or the extruded pre-fiber, is contacted with a nonsolvent (e.g., a coagulation medium such as water) that is incompatible with the polymers. The resulting sheet or fiber is allowed to set or gel as a phase inverted membrane. The set membrane is then leached to remove the solvent and other soluble ingredients.

Preparation of hollow fiber membranes by phase inversion includes melt-spinning, wet spinning or dry-wet spinning. In a typical process for preparing a hollow fiber membrane by dry-wet and wet-wet spinning processes, a viscous polymer solution comprising a blend of at least two miscible polymers, solvent and optionally, at least one of a pore former, a nonsolvent and a wetting agent, is pumped through an extrusion head. The polymer solution is well-mixed and stirred to provide a homogenous solution or a colloidal dispersion, and is filtered and degassed before it enters the extrusion head. A bore injection fluid is pumped through the inner orifice of the extrusion head. In a dry-wet spinning process, the pre-fiber extruded from the extrusion head, after a short residence time in air or a controlled atmosphere, is immersed in a nonsolvent bath to allow quenching throughout the wall thickness, and the fiber is collected. In a wet-wet spinning process, the extruded pre-fiber does not have residence time in air or a controlled atmosphere, e.g., it passes from the extrusion head directly into a nonsolvent bath to allow quenching throughout the wall thickness.

The pore structure can be controlled by, for example, utilizing a pore former and/or a non-solvent in the casting solution or spinning dope. Alternatively, or additionally, the pore structure of the membrane can be controlled by, for example, utilizing a second polymer component with branched components that will straighten or coil depending on the pH of the environment (e.g., the pH of the nonsolvent contacting the cast solution or film, or the pH of the bore fluid and/or the coagulation medium contacting the pre-fiber).

A plurality of filter elements can be utilized in accordance with the invention wherein at least one element comprises a blended polymer membrane. In some embodiments, at least one filter element consists of, or consists essentially of, a blended polymer membrane as described above. However, filter media according to the invention can also include additional materials and media such as porous inorganic media, mono- or multi-component granular media such as sand, anthracite, garnet and/or carbon, porous metal media, porous ceramic media, porous mineral media, porous media comprising organic and/or inorganic fibers such as carbon and/or glass fiber media, and/or other porous polymeric media, including fibrous polymeric media. The filter media can include chemically, catalytically, and/or physically active media, such as various resins, e.g., ion exchange resins, such as water softeners or demineralizers, zeolites, various “activated” forms of carbon, e.g., granular activated carbon, sorbents, catalysts, getters and/or biocides.

Porous filter media (including porous blended polymer membranes) having a wide variety of pore sizes or structures or removal ratings may be used with the present invention. The pore size or removal rating used depends on the composition of the aqueous fluid to be purified and the desired purity level of the fluid.

In some embodiments, the blended polymer membrane is semipermeable. Preferably, the at least one filter element comprising a blended polymer membrane, is, at most, microporous. More preferably, the removal rating of the filter element is small enough to capture particulates and microorganisms such as bacteria and/or protozoa, such as E. coli, Cryptosporidium and Giardia, and viruses. In some embodiments, the blended polymer-medium, when used to filter water to provide drinking water, ensures the turbidity of the filtered water is no higher than 1 nephelolometric turbidity units (NTU), more preferably, no higher than 0.3 NTU in 95% of daily samples in any month, even more preferably, no higher than 0.05 NTU in 95% of daily samples in any month.

Microporous and ultrafiltration membranes are preferred, although nanofiltration and reverse osmosis (RO) membranes may be used. The removal rating of the filter element may be about 2 micrometers or less, in some embodiments about 1 micrometers or less, about 0.5 micrometers or less, about 0.2 micrometers or less, and even about 0.1 micrometers or less. In some embodiments, the filter element is microporous and has a removal rating in the range from about 0.02μ to about 2μ, more typically in the range of about 0.05μ to about 1.51μ.

In one embodiment, the filter assembly comprises a hollow fiber membrane module, the module comprising a plurality of hollow blended polymer membranes, and having a removal rating of about 0.1 micrometers. In another embodiment, the filter assembly comprises a plurality of ultraporous hollow fiber blended polymer membranes, and having a nominal molecular weight cutoff (MWCO) in the range from about 13,000 or less to about 100,000 Daltons (Da) or more.

For both the microporous and the ultrafiltration hollow fiber modules, fluid flow during filtration is preferably outside-in, where the aqueous fluid initially contacts the outside surface(s) of the hollow fibers, passes through to the interior surface(s) of the hollow fibers, and is directed to a suitable permeate outlet.

As noted above, the filter and/or filter assembly can comprise a plurality of filter elements, wherein at least one filter element comprises a blended polymer membrane. One or more filter elements may comprise filter media in pleated or in flat sheet form, e.g., as a fibrous sheet, or a semipermeable or a porous membrane. Alternatively, or additionally, one or more filter elements may be configured as a cylindrical element, e.g., a cylindrical hollow or solid fibrous mass, a hollow fiber, a spiral wound configuration, or a hollow pleated configuration, such as a straight, radial pleat design or a non-radial configuration, as disclosed, e.g., in U.S. Pat. No. 5,543,047 and U.S. Pat. No. 6,113,784, or a cross flow filter element, such as disclosed in International Publication No. WO 00/13767.

With respect to a plurality of filter elements, the filter and/or filter assembly can also include at least one prefilter element, e.g., to remove larger particles and/or organisms so that the downstream filter element(s) may not foul so quickly, or at all. In some embodiments, the prefilter element(s) and downstream filter element(s) are disposed in separate filter assemblies. The removal rating of the prefilter element is not particularly limited, but is larger than that of the downstream filter element(s).

In one embodiment of a filter according to the invention, the filter comprises at least a first filter element and a second filter element, wherein at least the first filter element comprises a blended polymer membrane, and the second filter element comprises at least one hollow fiber membrane, more preferably, wherein the first filter element includes a prefilter element, and the second filter element comprises two or more hollow fiber membranes.

For example, in an embodiment the filter (disposed in a housing) comprises a first filter element and a second filter element, the first filter element comprising a hollow filter element comprising a porous blended polymer membrane (e.g., a membrane sheet arranged in the form of a cylinder), the membrane comprising a blend of a first, essentially hydrophobic polymer component and a second polymer component that is a homopolymer or a random copolymer entangled with the first polymer component, the second polymer component being more hydrophilic than the first polymer component; and, the second filter element comprising a plurality of porous hollow fiber membranes, the second filter element being disposed in the hollow portion of the first filter element. During use of the filter, the aqueous fluid to be treated passes from the outside surface of the first filter element through the inside surface into the hollow portion of the first filter element (thus removing the larger particles from the aqueous fluid), and a portion of the treated fluid passes through the second filter element in an outside-in manner. Accordingly, permeate passes from the outside surface of a hollow fiber membrane and along the bore and inside surface of the hollow fiber membrane, and through a permeate outlet. Additionally, a portion of fluid passes along the outside surface of the hollow fiber membrane and through a retentate outlet without passing through the hollow fiber membrane. Preferably, the filter can be cleaned, more preferably, by backwashing, wherein the cleaning fluid is passed through the filter in the direction opposite from which fluid flows during filtration.

In some embodiments, the second filter element comprises at least one porous blended polymer hollow fiber membrane, the membrane comprising a blend of a first, essentially hydrophobic polymer component and a second polymer component that is a homopolymer or a random copolymer entangled with the first polymer component, the second polymer component being more hydrophilic than the first polymer component. The first filter element can have a cylindrical inner and outer periphery, or it can have other peripheral shapes, such as oval or polygonal.

As noted above, the filter element and/or filter may comprise a composite including additional layers, or the filter element and/or filter may further comprise separate layers, that are in fluid communication with the filter medium or media. Additional layers include, for example, support and/or drainage layers and/or cushioning layers. In accordance with embodiments of the invention, the additional layer(s) can be adjacent the upstream and/or the downstream surface of the filter or filter element. The use of additional layers upstream and downstream of the filter element can be particularly suitable for those applications wherein fluid to be filtered passes in one direction through the filter element, and a cleaning fluid passes in the other direction through the filter element, and/or, for example, the filter comprises a plurality of pleated filter elements disposed atop one another.

In some embodiments, a plurality of layers can be arranged upstream and/or downstream of the filter element. For example, a drainage layer and a support layer can be disposed upstream and/or downstream of the filter element (e.g., wherein the drainage layer is interposed between the filter element and the support layer). For example, in the embodiment illustrated in the Figure, wherein one pleat of an embodiment of a pleated filter element 50 is shown, first and second drainage layers 11 are arranged adjacent the first (e.g., upstream) and second (e.g., downstream) surfaces respectively of the blended polymer membrane 1, and first and second support layers 21 are arranged next to the drainage layers (e.g., the first support layer is upstream of the first drainage layer, and the second support layer is downstream of the second drainage layer). Such an arrangement can be particularly desirable for those applications wherein the filtration flow is in one direction through the filter element, and the element is cleaned by passing a cleaning fluid through the filter element in the direction opposite of filtration flow.

Suitable support, drainage and/or cushioning layers preferably have low edgewise flow characteristics, i.e., low resistance to fluid flow through the layer in a direction generally parallel to its surface. Examples include, for example, meshes and porous woven or non-woven sheets (in the Figure, the illustrated support layers 21 each comprise a mesh, and the illustrated drainage layers 11 each comprise a porous sheet). However, in some embodiments, membranes, e.g., having large pores, can be utilized, particularly for drainage and/or cushioning, regardless of their edgewise flow characteristics. Meshes are usually preferable to porous sheets because they tend to have a greater open area and a greater resistance to compression in the thickness direction. For high temperature applications, a metallic mesh or screen may be employed, and for lower temperature applications, a polymeric mesh may be particularly suitable. Suitable meshes include those having less resistance to edgewise flow in one direction than the other direction, or meshes that do not have a single preferred flow direction. In some embodiments wherein membranes are utilized, e.g., for drainage and/or support, at least one membrane can be a blended polymer membrane, preferably, a cleanable blended polymer membrane, as described above.

The transmembrane pressure (TMP) that may be applied across the filter medium depends upon the filter system, the desired flow rate, and the degree of fouling of the filter medium. For example, using a filter module comprising a plurality of hollow fibers and being about 3 to about 6 inches (about 7.6 to about 15.2 cm) in diameter and about 24 inches to about 6.4 feet (about 61 to 200 cm) long, the application of a TMP of about 5 to 30 psi (about 34.5 to about 206.7 kPa) may result in a flow rate of about 5 to about 40, preferably about 10 to about 25, gallons per minute.

Because filter media according to embodiments of the invention exhibit reduced fouling, the flux of aqueous fluid through the filter media may be increased for a given transmembrane pressure (TMP). Also, the TMP that may be applied during filtration may be lower and may increase more slowly, if at all, to maintain a certain rate of flux of fluid through the filter medium. As a result, the limit of TMP that may be used to force aqueous fluid through the filter medium may be reached more slowly, if at all. Accordingly, not only is the flux of aqueous fluid (e.g., water) increased but also filtration may be performed for longer periods of time before stopping to clean the filter medium, or non-chemical cleaning (sometimes referred to as “flux maintenance”) may be effective for longer periods of time before chemical treatment (e.g., via chemical agents) or even caustic treatment, to clean the medium is needed.

In accordance with typical embodiments of a method according to the invention, an aqueous fluid to be treated, preferably, source water to be filtered, is passed through a filter including at least one filter element comprising a blended polymer membrane (e.g., disposed in a filter assembly) to provide a purified filtrate, effluent, or permeate. Filtration is continued for a desired period of time, or, for example, until the flux decreases to a predetermined value or range or the differential pressure increases to a predetermined value or range. Filtration is then stopped, and the filter is cleaned. After cleaning, filtration is resumed, and additional aqueous fluid to be treated is passed through the membrane until cleaning is again appropriate. Typically, the membrane is cleaned a number of times using a non-chemical treatment (e.g., water and/or gas) before a chemical treatment is utilized. For example, in one embodiment, over a 24 hour period, the filter may be cleaned non-chemically several times, and cleaned chemically once. In another protocol, the filter may be cleaned non-chemically at least once a day, and cleaned chemically once a week, or once every 30 days, for example.

A variety of cleaning protocols are suitable for use with the invention. For example, the filter element can be cleaned by backwashing, i.e., by forcing a suitable cleaning fluid under pressure through the filter in the direction opposite from which fluid flows during filtration. In accordance with another cleaning protocol, the filter element can be cleaned by crossflow cleaning, wherein the cleaning fluid is passed along the upstream surface of the filter, i.e., so as to produce crossflow along the filter surface rather than passing through the filter medium as in backwashing. The crossflow can be in the same direction as normal filtration flow, or in the opposite direction across the surface. The cleaning fluid used in these protocols can be a liquid, gas (e.g., for air scrubbing), or a mixture of gas and a liquid. In some embodiments, the cleaning fluid can include, for example, at least one enzyme and/or at least one chemical agent such as a solvent. Illustrative cleaning protocols include, but are not limited to, those disclosed in International Publication No. WO 00/13767.

Because filter media according to embodiments of the invention exhibit reduced fouling, and can be easily cleaned, the cleaning fluid can be used under less pressure than would be utilized in conventional applications, thus reducing stress to the filter media during cleaning. Moreover, in some embodiments, the reduced fouling and ease of cleaning reduces or eliminates the need for support and/or drainage layers. Alternatively, support and/or drainage layers having less rigidity or strength than conventional layers can be used, and stress to the membrane caused by forcing a surface of the membrane against the support and/or drainage layer can be reduced.

Filtrate or permeate passing through the filter medium, as well as retentate (if any) can be further treated as is known in the art. For example, the filtrate or permeate can be passed through additional filter media (e.g., one or more filter assemblies), and retentate can be recirculated to the source or to any other components of the water treatment system. The filtrate or permeate can be distributed as drinking water and/or can be used for other non-drinking purposes, such as in an industrial process, e.g., as the production of ultra pure water in microelectronics manufacturing.

The type of filter assembly utilized in the invention is not particularly limited. For example, a dead-end filter assembly and/or a cross-flow filter assembly may be used. The filter assembly may be configured in a wide variety of ways. For example, the filter assembly may be configured as a plate-and-frame or stacked plate filter assembly, or a dynamic filter assembly. Preferably, the filter assembly is configured as an array of filter cartridges or filter modules.

A variety of filter assemblies (including primary, secondary, and tertiary assemblies, and dynamic filter assemblies), modules, cartridges, and systems (including subsystems) can be used in accordance with the invention. Examples of suitable modules, cartridges, filter assemblies, and systems include, but are not limited to, those disclosed in International Publication Nos. WO 00/13767, WO 01/16036, WO 97/02087 and WO 97/13571.

Filter assemblies according to the invention may be used in any water purification system. Examples of suitable purification systems include a batch system with an open loop, a batch system with a closed loop, a single-stage continuous system, a multistaged arrangement with recirculation, and a multistaged arrangement without recirculation, as described, for example, in Water Treatment Membrane Processes, American Water Works Association Research Foundation et al., 1995, pages 2.22-2.24.

In accordance with embodiments of the invention, the water purification system can also provide, for example, treatment of the water by or with at least one of irradiation, radiation (e.g., UV radiation, and broadband radiation (including broadband UV radiation)), and oxidation, e.g., by the addition of agents such as chlorine (Cl₂), chlorine dioxide (ClO₂), ozone, or hydrogen peroxide. Illustratively, treating the water can reduce or prevent fouling of the porous medium, e.g., by decreasing the biofilm and/or destroying microbes. Thus, the flux of water through the porous medium can be increased for a given differential pressure or transmembrane pressure.

In some embodiments of systems and methods for treating source water or wastewater, the purified water, prior to being discharged, may be subject to a “last-chance” or “fail-safe” purification assembly, including an additional filter assembly. During normal operating conditions, the last-chance purification assembly may remove few, if any, contaminants because the portion of the source water or wastewater treatment system upstream of the last-chance purification assembly (i.e., the purification subsystem) has already removed the contaminants to the desired level of purification. However, during abnormal conditions, e.g., failure of one or more of the components of the purification subsystem or an abnormally high concentration of contaminants, the last-chance purification assembly removes a significant amount of the contaminants. The filter assembly utilized with the purification assembly may be similar or identical to any of the filter assemblies previously described, and the type, configuration and/or pore rating may depend on, for example, the various contaminants to be removed and the desired level of purity. However, it may be desirable to target specific contaminants to be removed during abnormal conditions, e.g., biological contaminants including organisms such as Cryptosporidium and Giardia, and select the characteristics of the filter assembly in accordance with these targets. For example, the removal rating of the fail-safe filter element may be small enough to capture particulates and microorganisms such as bacteria and/or protozoa (e.g., Cryptosporidium and Giardia), or viruses. Alternatively, it may be desirable to target all of the potential contaminants and more generally design the characteristics of the filter assembly in accordance with these general targets.

The following examples further illustrate the invention but, of course, should not be construed as in any way limiting its scope.

### EXAMPLE 1

This example demonstrates the preparation of a porous blended polymer membrane having a first, essentially hydrophobic polymer and a second polymer that is a random copolymer entangled with the first polymer, the second polymer being more hydrophilic than the first polymer, the second polymer being present in a ratio to the first polymer that is substantially uniform at the surfaces and through the bulk of the membrane.

A 23000 g batch of polymer solution containing 17% solids by weight is prepared by dissolving the solids in a 75/25% DMAC/EAA (dimethyl acetamide/ethyl acetoacetate) solution with the solids consisting of 80 wt % PVDF (Kynar 761/761A, 50/50 mix) and 20% comb polymer (a random copolymer with a poly (methyl acrylate) (Ma) backbone and polyoxyethylene methacrylate (POEM) and hydroxy-terminated polyoxyethylene methacrylate (HPOEM) side chains P(Ma-r-POEM-r-HPOEM)) (Doresco AC403-5; Dock Resins Corp., Linden, N.J.). The dissolution temperature is 44.6° C.

The solution is well mixed overnight at a mixer speed of 350 rpm in a closed stainless steel reactor. The polymer solution is the cast onto a glass plate using an aluminum casting bar with a thickness gap of 13 mils (about 330 micrometers). The cast membrane is then submerged in a casting bath consisting of 52%/7%/41% DMAC/EAA/water for five minutes. The sample is then submerged in running deionized water and allowed to wash overnight. The sample is then placed in a frame, sealed in an aluminum bag with approximately 200 ml of water and place in an oven at 95° C. for 16 hrs. The sample is then removed, dried at 100° C. for ten minutes, and evaluated.

The CWST is determined as described in U.S. Pat. No. 4,925,572, and the KL is determined as described in U.S. Pat. No. 4,340,479.

The results are as follows:

| | | | Water Flow | | | |
|---|---|---|---|---|---|---|
| CWST | | | (L/min/ | | Thickness | |
| (Dynes/cm) | K_{L} (psi) | | ft²)@30 psi | | (mils) | |
| Dry | Wet | Dry | Wet | Dry | Wet | Dry |
| 72.4 | 40-42 | 30-32 | 14.7 | 22.6 | 5.50 | 4.55 |

The concentration of the comb polymer at the top and bottom surfaces of the membrane is about 18 mole %.

### EXAMPLE 2

This example demonstrates that embodiments of membranes prepared according to the invention can be repeatedly cleaned while maintaining desired performance characteristics.

Two membranes are prepared as generally described in Example 1, except the dissolution temperature is 39.7° C. The membranes have a removal rating of 0.05 micrometers, and (when dried) a K_{L} of 55 psi.

Two filters are assembled, each having (from the upstream to downstream direction) a channeled mesh (0.030D; Delstar Technologies, Inc.; Middletown, Del.) (upstream support layer), a PVC nonwoven layer (1 oz/yd²) (an upstream drainage layer), the membrane, and a TYPAR® 3401 (Reemay, Inc.; Old Hickory, Tenn.) layer (a downstream cushioning layer).

A first filter is placed in a jig, and used to filter surface water for 70 hours. The filtration flow rate is 0.05 gallons per minute per square foot (gpm/ft²). Every hour, the filter is backwashed with water (corresponding to 4% of the filtrate) at 30 psi for 15 seconds, followed by rinsing the housing and the upstream surface of the filter. Every third hour, the jig is inverted, and water and air is passed over the upstream surface of the filter, and the jig is inverted again, and water and air is passed over the downstream surface of the filter, using 1000 ml of water and about 35 psi air, for 30 seconds. The filter in the jig is then backwashed as described above. After 70 hours, the filter is backwashed for 30 minutes using 0.4% NaOH and 300 ppm NaOCl, followed by water and air washing as described in the every 3 hour protocol above.

The used first filter, and the unused second filter, are each used to filter water in a jig. Both filters are used to filter surface water for 11 hours. The filtration flow rate is 0.05 gpm/ft², and both filters are cleaned every hour and every 3 hours as described with respect to the first filter above.

The differential pressure measured each hour for each filter after cleaning is comparable, showing a membrane used for 70 hours and repeatedly cleaned with water, and then chemically cleaned, has similar performance characteristics to a new membrane.

### EXAMPLE 3

This example demonstrates that embodiments of membranes prepared according to the invention can be repeatedly backwashed with water so that a high percentage of the increase in differential pressure is removed. In this experiment, about 60 to about 80% of the build up in differential pressure is removed upon backwashing with water.

A 750 lb batch of polymer solution is made as follows. The non-solvents ethylene glycol (4 parts), ethylene glycol monomethyl ether (5 parts), acetone (32) parts, and methyl acetate (9 parts) are added in a reactor and mixed. PVDF (Kynar-761 resin) (15 parts) is added to the reactor containing the nonsolvents. A vessel is filled with DMAC (29.3 parts) and stirred. Comb polymer (Doresco AC403-5; Dock Resins Corp.) (5.7 parts) is then added to the DMAC vessel and stirring continues until blending is complete. The polymer/solvent mixture is added to the reactor containing the non-solvents/resin. The reactor is slowly heated to 130° F. (about 53.9° C.) (overnight) while continuing with agitation (approximately 600-rpm). The batch temperature is 148.7° F. (about 64.2° c).

The resin solution is cooled to 135° F. (about 56.7° C.) and maintained at this temperature during casting. The resin is cast onto a moving stainless steel belt using a slot dye into a film approximately 20 mil (about 508 micrometers) thick. The polymer film is then exposed to a temperature controlled humidified environment for about 8 minutes to form a nascent membrane. The nascent membrane is then immersed in deionized water to remove the solvents from the membrane. The membrane is then washed with hot deionized water for about 15 minutes to remove any residual solvents, non-solvents, and pore formers. The membrane is dried at 60° C. The membrane has a removal rating of 0.06 micrometers.

The membrane is placed in a jig. The membrane is used to filter surface water for 7 hours at a rate of 0.05 gpm/ft². The membrane is backwashed with water every hour, and the differential pressure is measured before and after backwashing. After backwashing, the differential pressure returns to a high percentage of the previous differential pressure, e.g., for each hourly cycle, the ratio to washed differential pressure to built up differential pressure is about 60 to about 80%.

### EXAMPLE 4

This example demonstrates that embodiments of membranes prepared according to the invention can be repeatedly cleaned and exposed to hot water without affecting the stability of the blended chemistry.

Two membranes are prepared as described in Example 3. The first membrane is placed in a jig, and used to filter 70° C. clean water at a flow rate of 0.5 gpm/ft² for 800 hours.

The used first membrane, and the unused second membrane, are each used to filter water in a jig. Each membrane is used to filter ambient temperate surface water at a flow rate of 0.05 gpm/ft² for 5 hours. Each membrane is cleaned every hour by backwashing with 35 ml of water and air at 50 psi followed by rinsing the jig and upstream surface of the membrane for 1 minute.

The built up differential pressure for each membrane is comparable, showing a membrane used to filter hot water for over 800 hours does not substantially affect the blended chemistry.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Of course, variations of those preferred embodiments will become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of treating an aqueous fluid comprising:
directing the flow of an aqueous fluid to be treated through a blended polymer membrane having an upstream surface and a downstream surface, the membrane comprising a blend of a first, essentially hydrophobic polymer component and a second polymer component comprising a comb polymer that is a random copolymer or a homopolymer entangled with the first polymer, the second polymer component being more hydrophilic than the first polymer component, the second polymer component being present at the upstream surface in a ratio to the first polymer component that is greater than the overall ratio in the membrane of the second polymer component to the first polymer component;
stopping the flow of the aqueous fluid through the membrane;
cleaning the membrane; and
directing the flow of additional aqueous fluid to be treated through the membrane.

2. A method of treating an aqueous fluid comprising:
directing the flow of an aqueous fluid to be treated through a blended polymer membrane having an upstream surface and a downstream surface, the membrane comprising a blend of a first, essentially hydrophobic polymer component and a second polymer component comprising a comb polymer that is a random copolymer or a homopolymer entangled with the first polymer component, the second polymer component being more hydrophilic than the first polymer component, the second polymer component being present in a ratio to the first polymer component that is substantially uniform at the surfaces and through the bulk of the membrane;
stopping the flow of the aqueous fluid through the membrane;
cleaning the membrane; and
directing the flow of additional aqueous fluid to be treated through the membrane.

3. A method of treating an aqueous fluid comprising:
passing an influent aqueous fluid through a blended polymer hollow fiber membrane having an inside surface, an outside surface, and a bore, to provide an effluent aqueous fluid, the effluent aqueous fluid containing a lower concentration of undesirable material than the influent aqueous fluid,
the hollow fiber membrane comprising a blend of a first, essentially hydrophobic polymer component and a second polymer component comprising a comb polymer that is a random copolymer or a homopolymer entangled with the first polymer component, the second polymer component being more hydrophilic than the first polymer component.

4. The method of claim 3, comprising directing the influent aqueous fluid through the outside surface of the membrane, and passing the effluent aqueous fluid along the inside surface and through the bore of the membrane.

5. The method of claim 1, wherein the membrane comprises a porous membrane.

6. The method of claim 1, wherein the membrane comprises a semipermeable membrane.

7. A membrane comprising:
a blended polymer membrane having an upstream surface and a downstream surface, the membrane comprising a blend of a first, essentially hydrophobic polymer component and a second polymer component comprising a comb polymer that is a homopolymer or a random copolymer entangled with the first polymer component, the second polymer component being more hydrophilic than the first polymer component, the second polymer component being present in a ratio to the first polymer component that is substantially uniform at the surfaces and through the bulk of the membrane.

8. (canceled)

9. A membrane comprising:
a blended polymer hollow fiber membrane having an inside surface and an outside surface, and a bore defined by the inside surface, the membrane comprising a blend of a first, essentially hydrophobic polymer component and a second polymer component comprising a comb polymer that is a random copolymer.or a homopolymer entangled with the first polymer component, the second polymer component being more hydrophilic than the first polymer component, the second polymer component being present in a ratio to the first polymer component that is substantially uniform at the surfaces and through the bulk of the membrane.

10. A membrane comprising:
a blended polymer hollow fiber membrane having an inside surface and an outside surface, and a bore defined by the inside surface, the membrane comprising a blend of a first, essentially hydrophobic polymer component and a second polymer component comprising a comb polymer that is a random copolymer or a homopolymer entangled with the first polymer component, the second polymer component being more hydrophilic than the first polymer component, the second polymer component being present at the inside surface or the outside surface in a ratio to the first polymer component that is greater than the overall ratio in the membrane of the second polymer component to the first polymer component.

11. The membrane of claim 9, wherein the second polymer component is present at the inside surface in a ratio to the first polymer component that is greater than the overall ratio in the membrane of the second polymer component to the first polymer component.

12. The membrane of claim 9, wherein the second polymer component is present at the outside surface in a ratio to the first polymer component that is greater than the overall ratio in the membrane of the second polymer component to the first polymer component.

13. The membrane of claim 7, wherein the membrane comprises a porous membrane.

14. The membrane of claim 7, wherein the membrane comprises a semipermeable membrane.

15-21. (canceled)

22. The membrane of claim 7, wherein the membrane is a microporous membrane.

23. The membrane of claim 7, wherein the membrane is a nanoporous membrane.

24. The membrane of claim 7, wherein the membrane has a removal rating of about 2 micrometers or less.

25-27. (canceled)

28. The method of claim 3, further comprising:
stopping the flow of the aqueous fluid through the membrane;
cleaning the membrane; and
directing the flow of additional aqueous fluid through the membrane.

29. The method of claim 1, wherein cleaning the membrane includes backwashing the membrane.

30. The method of claim 1, wherein cleaning the membrane includes chemically treating the membrane.

31. The method of claim 1, wherein cleaning the membrane includes air scrubbing the membrane.

32. The method of claim 1, including stopping the flow of aqueous fluid, cleaning the membrane, and directing the flow of additional aqueous fluid through the membrane, two or more times.

33. The method of claim 1, including removing contaminants in the aqueous fluid to a desired level of purification.

34. The method of claim 1, wherein the aqueous fluid comprises source water.

35. The method of claim 1, wherein the first polymer component comprises a halopolyolefin, polyacrylonitrile, or a sulfone.

36. The method of claim 1, wherein the comb polymer includes a halopolyolefin backbone, a methyl acrylate backbone, a polyacrylonitrile backbone, or a sulfone backbone.

37. The method of claim 1, wherein the first polymer component comprises polyvinylidene fluoride and the comb polymer includes a polyvinylidene backbone or a methyl acrylate backbone.

38. The membrane of claim 7, wherein the first polymer component comprises a halopolyolefin, polyacrylonitrile, or a sulfone.

39. The membrane of claim 7, wherein the comb polymer includes a halopolyolefin backbone, methyl acrylate backbone, a polyacrylonitrile backbone, or a sulfone backbone.

40. The membrane of claim 7, wherein the first polymer component comprises polyvinylidene fluoride and the comb polymer includes a polyvinylidene backbone or a methyl acrylate backbone.
